(19) United States
(12) Patent Application Publication
(10) Pub. No.: US 2023/0040221 A1
(43) Pub. Date: Feb. 9, 2023

(54) FLUID-HEATING DEVICE, IN PARTICULAR INTENDED FOR A VEHICLE

(71) Applicant: Valeo Systemes Thermiques, Le Mesnil Saint Denis (FR)

(72) Inventors: Laurent Decool, Le Mesnil-Saint-Denis (FR); Jonathan Fournier, Le Mesnil-Saint-Denis (FR); Nicolas Siffrein-Blanc, Le Mesnil-Saint-Denis (FR)

(73) Assignee: Valeo Systemes Thermiques, Le Mesnil-Saint-Denis (FR)

(21) Appl. No.: 17/787,093

(22) PCT Filed: Dec. 7, 2020
(86) PCT No.: PCT/FR2020/052291

§ 371 Date: Jun. 17, 2022

(30) Foreign Application Priority Data
Dec. 18, 2019 (FR) FR1914697

(51) Int. Cl. F24H 9/20; F24H 1/00; H05B 1/02; B60H 1/22

(52) U.S. Cl. CPC F24H 9/2028; F24H 1/009; H05B 1/0236; B60H 1/2221

(57) ABSTRACT

The present invention relates to an electrical fluid-heating device, in particular intended for a motor vehicle, comprising at least one electrical heating element (4) intended to heat the fluid, a temperature sensor (83) intended to give information about the temperature of the fluid, a switch (87), called inrush current switch, intended to create an inrush current in a power supply circuit (88) of said one or more electrical heating elements, an opening means (89) for opening said circuit in the event of said inrush current occurring, the temperature sensor (83) and the inrush current switch (87) being positioned independently of one another, the heating device being configured so as to transmit a signal from the temperature sensor (83) to the inrush current switch (87).

The invention relates to a fluid heating device, in particular intended for a vehicle, more particularly for an installation for ventilating, heating and/or air conditioning the vehicle interior and/or the thermal regulation of a battery. It may be in particular an electric or hybrid vehicle that is able to be autonomous.

It is known practice to heat the air intended for the thermal treatment of a vehicle interior through the exchange of heat between an air flow and a heat transfer liquid, using a heat exchanger. In the case of hybrid or electric vehicles, electric heating devices that form a source of heat energy, through which an electric current is circulated to raise the temperature of electric heating elements placed in contact with the heat transfer liquid are known. Heat energy is then exchanged between the electric heating elements and the heat transfer liquid, which in turn heats up before heating the car interior by virtue of the exchanger.

To prevent any overheating, document EP 2 884 519 teaches the use of a means for opening the power supply circuit for the electric heating elements. Said means is actuated through the deformation of a bimetallic strip placed in contact with said electric heating elements. The bimetallic strip deforms when the temperature of the electric heating elements reaches a certain predefined threshold, and ensures the actuation of the means for opening the circuit by means of a leaf.

Such a solution for preventing overheating has a major drawback due to the fact that the bimetallic strip, in order to be positioned correctly with respect to the electric heating elements, must have a specific shape of costly construction. In addition, the bulk resulting from the mechanical coupling between the bimetallic strip and the opening means via the leaf reduces the margin of maneuver for mounting the assembly in the heating device, with the consequence in particular of the risk of the bimetallic strip being positioned outside the region of maximum heating.

It is therefore necessary to find a solution for preventing overheating of the electric heating elements of a heating device which is of simple construction and is easy to mount in said heating device.

The present invention aims to at least partly provide such a solution.

To that end, the subject of the invention is an electric fluid heating device, in particular for a motor vehicle, comprising at least one electric heating element intended to heat the fluid, a temperature sensor intended to give information on the temperature of the fluid, a switch, called the inrush current switch, intended to create an inrush current in a power supply circuit for said one or more electric heating elements, an opening means for opening said circuit in the event of said inrush current occurring, the temperature sensor and the inrush current switch being positioned independently of one another, the heating device being configured to transmit a signal from the temperature sensor to the inrush current switch.

Thus, with a temperature sensor mounted independently of the inrush current switch, the invention simplifies the assembly of the solution for preventing overheating by allowing each of these components to be positioned at the chosen relevant location.

The invention may also comprise any one of the following features, taken individually or in any technically possible combination forming as many embodiments of the invention:
the heating device comprises a means for transmitting the signal between the temperature sensor and the inrush current switch;
the means for transmitting the signal comprises an electrical conductor;
the heating device comprises a microcontroller able to control the inrush current switch;
the means for transmitting the signal provides the connection between the temperature sensor and the microcontroller;
the heating device further comprises an upstream switch and a downstream switch;
the electric heating element is connected in series to the upstream switch and to the downstream switch;
one of the upstream or downstream switches is configured to regulate a current flowing through the electric heating element;
the upstream switch and the downstream switch are connected to a control circuit board for controlling the current flowing through the electric heating element;
the means for opening the circuit comprises at least one fuse;
the fuse is connected in series with the electric heating element;
the means for opening the circuit is connected upstream of the upstream switch or downstream of the downstream switch;
the means for opening the circuit is configured to protect the electric heating element in the event of simultaneous failure of the upstream switch and of the downstream switch;
the inrush current switch is connected on a short-circuit line in parallel with the electric heating element;
the short-circuit line comprises a first end and a second end;
the first end of the short-circuit line is positioned between the electric heating element and the upstream switch and/or the second end of the short-circuit line is positioned between the electric heating element and the downstream switch;
the first end of the short-circuit line is positioned upstream of the upstream switch, and/or the second end of the short-circuit line is positioned downstream of the downstream switch;
the means for opening the circuit comprises at least one fuse;
the fuse is connected upstream of the first end of the short-circuit line or downstream of the second end of the short-circuit line;
the fuse is connected upstream of the inrush current switch;
the fuse is connected downstream of the inrush current switch;
the circuit board comprises a region that is thermally insulated with respect to a main region of said circuit board;
the temperature sensor is mounted in the insulated region of the circuit board;
the heating device further comprises a heat sink between a chamber for circulation of the fluid and the circuit board.

The invention will be better understood and further details, features and advantages of the invention will become apparent from reading the following description given by way of non-limiting example and with reference to the appended drawings, in which:

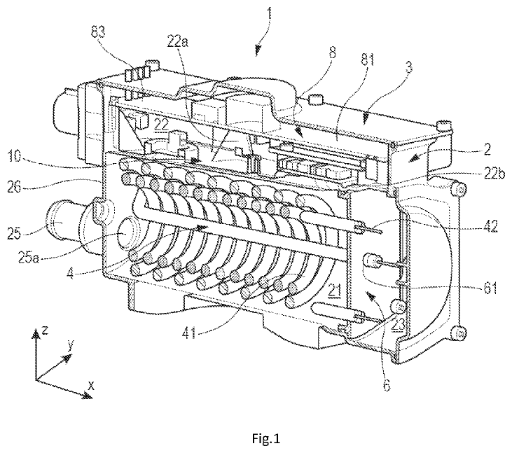

FIG. 1 is a longitudinal sectional view of a heating device according to the invention;

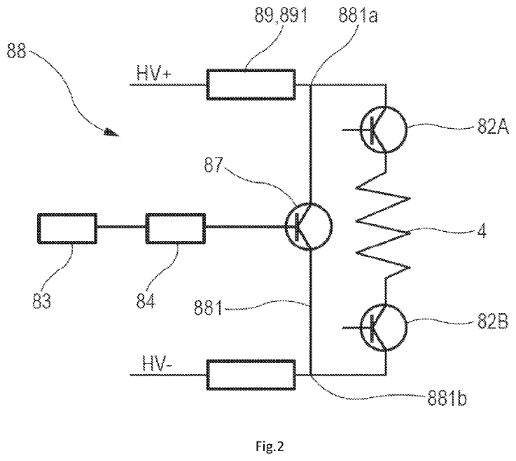

FIG. 2 shows a circuit diagram of the heating device according to the invention in a first embodiment;

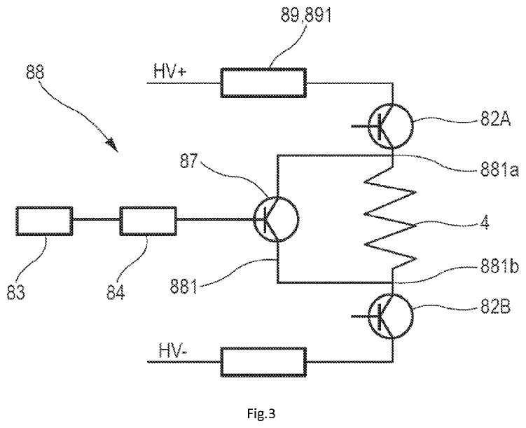

FIG. 3 shows a circuit diagram of the heating device according to the invention in a second embodiment.

It should first of all be noted that, in all of the figures, elements that are similar and/or perform the same function are indicated by the same reference.

By convention, unless stated otherwise, the term “longitudinal” applies to the direction in which the largest dimension of the electric heating device extends, the term “transverse” applies to a direction substantially perpendicular to the longitudinal direction, and the term “vertical” refers to the direction perpendicular both to the longitudinal direction and to the transverse direction.

Furthermore, with reference to the orientations and directions defined above, the longitudinal direction will be represented by the axis Ox, the transverse direction will be represented by the axis Oy, and the vertical direction will be represented by the axis Oz. These various axes together define an orthonormal reference system Oxyz shown in FIG. 1. Within this reference system, the terms “top” or “upper” will be represented by the positive direction of the axis Oz, the terms “bottom” or “lower” being represented by the negative direction of this same axis Oz.

As is illustrated in FIG. 1, the invention relates to a heating device 1. Said device is used for heating a fluid, in particular a heat transfer liquid. Said device comprises a housing 2 for circulation of the fluid, at least one heating element 4, two in this instance, a cover 6 supporting said one or more heating elements, and a control unit 8 for controlling a power supply current for said one or more heating elements.

In particular, the housing 2 defines a first chamber 21 for circulation of the fluid, which first chamber is arranged so as to accommodate said one or more electric heating elements 4 such that the fluid circulating in said housing is brought into contact with said one or more electric heating elements. The housing 2 also defines a second chamber 22 in which is housed the control unit 8 for controlling the current circulating in said one or more electric heating elements 4. Lastly, the housing defines a third chamber 23 which is separated from the first chamber 21 by means of the cover 6.

The housing 2 is formed, for example, by die-casting aluminum and/or an aluminum alloy.

To circulate the fluid in the chamber 21, the housing 2 comprises at least a first, inlet pipe (not shown) and at least a second, outlet pipe 25 in communication with said chamber 21. The inlet pipe and the outlet pipe 25 are arranged on one and the same side of the housing 2, in this instance at a bottom 26 of the housing 2.

The outlet pipe 25 leads directly into the chamber 21 through a first aperture 25a. The inlet pipe leads into the chamber 21 by way of a second aperture formed at one end of said chamber, opposite the bottom 26. The inlet pipe comprises a channel longitudinally bordering the chamber 21 and leading into said chamber.

Each electric heating element 4 comprises a shielded resistor 41 arranged in a spiral and also at least one connection terminal 42 intended to connect said resistor to a current supply source. Said electric heating elements 4 extend longitudinally in the housing 2 through the cover 6.

To this end, the cover 6 comprises openings 61 in which the electric heating elements 4 are mounted in such a way that, for each of said electric elements, the resistor 41 extends in the first chamber 21 and the terminals 42 extend through the cover 6 and lead into the third chamber 23. The connection between said cover 6 and said terminals 42 is leaktight.

The second chamber 22 is located above the first chamber 21, along the latter, and has an upper edge closed off by means of an upper covering 3. Furthermore, the second chamber 22 comprises vertical projections 22a and also a platform 22b that are formed on a separating wall 10 between said second chamber and the first chamber 21.

The heating device further comprises at least one temperature sensor 83 intended to give information relating to the temperature of the fluid and/or of said one or more electric heating elements 4.

As illustrated in FIGS. 2 and 3, the heating device also comprises at least one switch 87, called the inrush current switch, intended to create an inrush current in a power supply circuit 88 for the electric heating elements 4, and at least one means 89 for opening said circuit in the event of said inrush current occurring. The electric heating elements 4 are connected in parallel in said circuit 88. The one or more switches 87 and the one or more means 89 for opening the current are integrated, for example, into the control unit 8.

According to the invention, the temperature sensor 83 and the inrush current switch 87 form two components mounted independently of one another.

Such dissociation makes it possible to mount the sensor 83 at a distance from the inrush current switch 87, said sensor and said switch each being able to be positioned at different locations in the heating device. Moreover, such dissociation makes it possible to provide a plurality of temperature sensors and a plurality of inrush current switches in one and the same heating device.

In particular, the inrush current switch 87 is connected on a short-circuit line 881 in parallel with one of the electric heating elements 4, said short-circuit line having an upstream end 881a and a downstream end 881b. The upstream position and the downstream position are defined here with respect to the direction of flow of the current.

According to one feature of the invention, the inrush current switch 87 reacts in the event of the thermal sensor 83 receiving information relating to the crossing of a threshold temperature by the heat transfer fluid and/or the electric heating elements 4 by closing the short-circuit line 881, the short-circuit line then shorting said one or more electric heating elements 4. The resistance of the power supply circuit then decreases sharply, which creates an inrush current and actuates the opening means 89. This opens the circuit 88 and switches said one or more electric heating elements 4 off.

The means 89 for opening the circuit 88 comprises at least one fuse 891 which is mounted or connected upstream of the first end 881a of the short-circuit line 881 or downstream of the second end 881b of the short-circuit line 881.

The power supply circuit 88 may comprise a set of switches 82 configured to regulate the current flowing through said one or more electric heating elements 4. Each electric heating element 4 is connected in series to a first current regulating switch, called the upstream switch 82A, which communicates with a pulse width modulation (PWM) generator of the control unit 8; and a second current regulating switch, called the downstream switch 82B, which ensures the safety of said electric heating element 4 in the event of failure of the upstream switch 82A.

The current regulating switches 82 are chosen from insulated-gate bipolar transistors (IGBTs) and/or metal-oxide-semiconductor field-effect transistors (MOSFETs), known for their ability to handle high supply powers as required in an electric or hybrid vehicle heating application.

In a circuit 88 comprising an upstream switch 82A and a downstream switch 82B for regulating the current flowing through an electric heating element 4, the means 89 for opening the circuit 88 according to the invention intervenes in the event of simultaneous failure of said upstream switch and of said downstream switch. Said means 89 is positioned upstream of the upstream switch 82A or downstream of the downstream switch 82B of the electric heating element 4.

Additionally, as illustrated in FIG. 2, the first end 881a of the short-circuit line 881 is connected to the circuit 88 upstream of the upstream switch 82A and the second end 881b of the short-circuit line 881 is connected to the circuit 88 downstream of the downstream switch 82B.

However, as illustrated in FIG. 3, the first end 881a of the short-circuit line 881 may be positioned directly upstream of the electric heating element 4, between said electric heating element 4 and the upstream switch 82A. The second end 881b of the short-circuit line may be positioned directly downstream of the electric heating element 4 between said electric heating element and the downstream switch 82B.

Such positioning of the ends 881a, 881b of the short-circuit line 881 prevents the actuation of the means 89 for opening the circuit 88 in the event of untimely triggering of the switch 87. Specifically, the short-circuit line 881 does not short the switches 82A, 82B which, in normal operation, may regulate the current flowing through the circuit 88.

Although FIG. 3 shows the fuse 891 positioned upstream of the upstream switch 82A, it is quite possible to envisage positioning said fuse between said upstream switch and the electric heating element 4. Such positioning of the fuse remains consistent with the spirit of the present invention.

Advantageously, the temperature sensor 83 may be positioned on an circuit board 81, and in particular in a region 812 that is thermally insulated with respect to a main region 813 of said circuit board. The means 89 for opening the circuit 88 may then be positioned in said main region 813 or on any other support formed in the second chamber 22 of the housing 2.

With a temperature sensor 83 positioned on the circuit board 81, the recording of an image of the temperature of the fluid contained in the first chamber 21 may be carried out using a heat sink located between said first chamber and said circuit board.

Advantageously, the connection between the temperature sensor 83 and the inrush current switch 87 is provided by a chosen signal transmission means. It is, for example, a means for transmitting a signal of an electrical nature, in particular an electrical conductor.

The signal transmission means is configured also to provide the connection between the temperature sensor 83 and one of the upstream 82A or downstream 82B switches via a microcontroller 84, said microcontroller allowing the operation of the inrush current switch 87 to be controlled.

In the case of a plurality of electric heating elements 4 connected in parallel, one and the same means 89 for opening the circuit 88, in particular one and the same fuse 891, and/or one and the same inrush current switch 87 could be used for multiple, or even all, of the electric heating elements. Specifically, a short-circuit made with respect to one electric heating element is sufficient to short all of the other electric heating elements of the heating device, since the current flows through the electrical line of least resistance.

1. An electric fluid heating device for a motor vehicle, comprising:
at least one electric heating element configured to heat the fluid,
a temperature sensor configured to provide information on the temperature of the fluid,
a switch, called the inrush current switch, intended to create an inrush current in a power supply circuit for said one or more electric heating elements,
an opening means for opening said circuit in the event of said inrush current occurring,
the temperature sensor and the inrush current switch being positioned independently of one another,
the heating device being configured to transmit a signal from the temperature sensor to the inrush current switch.

2. The heating device as claimed in claim 1, comprising a means for transmitting the signal between the temperature sensor and the inrush current switch.

3. The heating device as claimed in claim 2, wherein the means for transmitting the signal comprises an electrical conductor.

4. The heating device as claimed in claim 3, comprising a microcontroller able to control the inrush current switch, and wherein the means for transmitting the signal provides the connection between the temperature sensor and said microcontroller.

5. The heating device as claimed in claim 1, wherein the inrush current switch is connected on a short-circuit line in parallel with the electric heating element, said short-circuit line comprising a first end and a second end.

6. The heating device as claimed in claim 5, further comprising an upstream switch and a downstream switch connected in series with the electric heating element, said electric heating element being positioned between said upstream switch and said downstream switch, at least one of said upstream and downstream switches being configured to regulate a current flowing through said electric heating element.

7. The heating device as claimed in claim 6, wherein the first end of the short-circuit line is positioned directly upstream of the electric heating element, and/or the second end of the short-circuit line is positioned directly downstream of said electric heating element.

8. The heating device as claimed in claim 6, wherein the first end of the short-circuit line is positioned upstream of the upstream switch and/or the second end of the short-circuit line is positioned downstream of the downstream switch.

9. The heating device as claimed in claim 6, wherein the means for opening the circuit comprises at least one fuse mounted upstream of the first end of the short-circuit line or downstream of the second end of the short-circuit line, said fuse being configured to protect the electric heating element in the event of simultaneous failure of the upstream switch and of the downstream switch.

10. The heating device as claimed in claim 1, wherein the temperature sensor is mounted on a control circuit board for controlling an electric current flowing through the one or more electric heating elements, said device further comprising a heat sink between a chamber for circulation of the fluid and said circuit board.
